(19) United States
(12) Patent Application Publication
(10) Pub. No.: US 2017/0179715 A1
(43) Pub. Date: Jun. 22, 2017

(54) POWER ARCHITECTURE AND MANAGEMENT SCHEME FOR IOT APPLICATIONS

(71) Applicant: Intel Corporation, Santa Clara, CA (US)

(72) Inventors: Lilly HUANG, Portland, OR (US); Christopher SCHAEF, Lebanon, NH (US); Vaibhav VAIDYA, Portland, OR (US)

(21) Appl. No.: 14/977,257

(22) Filed: Dec. 21, 2015

(51) Int. Cl. H02J 1/10; H02M 3/07; H02J 7/00

(52) U.S. Cl. CPC H02J 1/102; H02J 7/0068; H02M 3/07

(57) ABSTRACT

Methods and apparatus for a power management integrated circuit (PMIC) for receiving energy from multiple energy harvesting sources. The PMIC comprises a boost converter to receive a plurality of first power supplies and to generate an intermediate voltage, the boost converter having a plurality of input terminals coupled to the plurality of first power supplies, and a switched capacitor charge pump to receive the intermediate voltage and to generate a second power supply is shown.

### FIELD OF THE INVENTION

Embodiments of the present invention relate to the field of integrated circuits; and more particularly, embodiments of the present invention relate to a power management integrated circuit (PMIC) for receiving power from multiple energy harvesting sources.

### BACKGROUND OF THE INVENTION

Advances in integrated circuits and microelectronics have enabled a new generation of scalable sensor networks. For example, a smart sensor node (also referred to as a smart sensor device) is becoming more and more popular and essential for Internet of Things (IOT) applications. As such, combining sensing, signal conditioning, digital processing, data logging, and wireless digital communications into smaller and smaller integrated circuits allows nodes of these networks to be placed in remote environmental locations and embedded more and more deeply into machines and structures. But powering such a wireless sensor node for the long term remains a challenge in many applications, and the more deeply this node is embedded, the more challenging it becomes to find ways to maintain a charge on its battery or energy storage element(s) (hereinafter, collectively referred to as a “battery”).

Therefore, powering sensor nodes and extending their battery life are ongoing challenges. Technology for solving this challenge is energy harvesting. Energy harvesting, or energy scavenging ambient energies from the operation environment, represents a promising way to automatically store and collect energy and eliminate battery maintenance. As such, energy harvesting or scavenging from an ambient source, such as a photovoltaic (PV) cell, a radio frequency (RF) device, a piezoelectric (PZT) material, and/or a thermoelectric generator (TEG), is an alternative solution rather than using a big stationary battery, which is inefficient due to the high cost of maintenance to periodically replace or recharge the battery in remote locations. However, in many applications, the source of ambient energy may be intermittent, the kinds of energy that can most easily be harvested may also change with the environmental conditions, and the range of voltages.

Furthermore, since each of these energy harvesters has its own unique power characteristics, the power management for an energy transducer is critical in order to harvest a maximum available power, supply a regulated voltage to a load, and charge a battery. Unfortunately, many of the conventional methods use a single source power management, and therefore do not simultaneously accumulate power/energy from multiple sources. However, some conventional methods do use multiple energy transducers, but it typically only switches between the one or more energy harvesting sources. Thus, these conventional methods do not harvest energy simultaneously. In addition, the power losses due to the conventional power management circuits are still significantly large, which cause a problem for a system on chip (SOC) integration or an application-specific integrated circuit (ASIC) integration that operates a smart sensor under size & weight constraints.

Accordingly, there has been a lack of an efficient method and apparatus for receiving and managing multiple inputs from multiple energy harvesting sources and accumulating the energy from all the input sources substantially at the same time.

### BRIEF DESCRIPTION OF THE DRAWINGS

The invention may best be understood by referring to the following description and accompanying drawings that are used to illustrate embodiments of the invention. In the drawings:

FIG. 1 is a conventional circuit diagram illustrating a single source power management according to prior art.

FIG. 2 is a block diagram illustrating an energy harvesting PMIC system according to one embodiment.

FIG. 3 is a detailed circuit diagram illustrating an energy harvesting PMIC with a two-stage hybrid switching topology according to one embodiment.

FIG. 4 is a graph illustrating current and time values when an energy harvesting PMIC is operated according to one embodiment.

FIG. 5 is a detailed circuit diagram illustrating power conversion and control of a two-stage topology according to one embodiment.

FIGS. 6A-B are a block diagram and a detailed circuit diagram, respectively, illustrating a battery-operating mode according to some embodiments.

FIG. 7 illustrates a computing system according to one embodiment.

### DETAILED DESCRIPTION OF THE PRESENT INVENTION

The following description describes methods and apparatus for a power management integrated circuit (PMIC) for receiving energy from multiple energy harvesting sources. Specifically, methods and apparatus for an energy harvesting PMIC with a two-stage hybrid switching topology. The first stage of the energy harvesting PMIC includes a boost converter that receives multiple input power supplies to generate an intermediate voltage, where the boost converter has multiple input terminals coupled to the multiple input power supplies. The second stage of the energy harvesting PMIC includes a switched capacitor charge pump that receives the intermediate voltage to generate a second power supply, where the second power supply is greater than the intermediate voltage and can power a load and charge a battery directly. The energy harvesting PMIC and these techniques described herein also advantageously address the issue on power management for multi-source energy harvesting and increase overall system power efficiency. In addition, the energy harvesting PMIC and these techniques described herein also provide improvements to the field of energy harvesting and integrated circuits. These improvements include providing a discontinuous conduction mode (DCM) that can operate with multiple inputs and outputs, eliminating the power losses inherited with a general stand-alone charge pump conversion, and allowing a bi-directional energy flow to/from the battery when the power received from the harvesting energy sources is not sufficient.

Furthermore, the energy harvesting power management, as described herein, may be configured for a smart sensor node and IOT applications. As used herein, an “IOT” (also referred to as an IOT device and an IOT application) refers to an application and/or device that includes sensing and/or control functionality as well as a WiFi™ transceiver radio or interface, a Bluetooth™ transceiver radio or interface, a Zigbee™ transceiver radio or interface, an Ultra-Wideband (UWB) transceiver radio or interface, a Wi-Fi-Direct transceiver radio or interface, a Bluetooth™ Low Energy (BLE) transceiver radio or interface, and/or any other wireless network transceiver radio or interface that allows the IOT application/device to communicate with a wide area network and with one or more additional devices.

As used herein, a “smart sensor node” (also referred to as a smart sensor device) refers to a device that receives an input from the physical environment and uses built-in compute resources to perform predefined functions upon detection of the specific input and then process data before forwarding it on. For example, these nodes are used for monitoring and control mechanisms in a wide variety of environments including smart grids, battlefield reconnaissance, exploration and many other sensing applications. Furthermore, the smart sensor node is also a crucial and integral element in the IOT, where the increasingly prevailing environment provides an array of devices that can be outfitted with a unique identifier (UID) to transmit data over the Internet or similar networks.

In one embodiment, a smart sensor node may be a component of a wireless sensor and an actuator network (WSAN), which includes multiple nodes, each of which is connected with one or more other sensors and sensor hubs as well as individual actuators. According to one embodiment, a smart sensor node includes, but is not limited to, a sensor, a microprocessor, and a communication device. The smart sensor node may also include transducers, amplifiers, excitation control, analog filters, and compensation. The smart sensor node also incorporates software-defined elements that provide functions such as data conversion, digital processing and communication to external devices. Therefore, a smart sensor node requires a power management, such as an energy harvesting PMIC that receives input from multiple energy sources (e.g., multiple smart sensor nodes) and harvests power from the input sources simultaneously in order to supply a regulated voltage to a load or to charge a battery of the smart sensor node.

In the following description, numerous details are set forth to provide a more thorough explanation of the present invention. It will be apparent, however, to one skilled in the art, that the present invention may be practiced without these specific details. In other instances, well-known structures and devices are shown in block diagram form, rather than in detail, in order to avoid obscuring the present invention.

Various embodiments and aspects of the inventions will be described with reference to details discussed below, and the accompanying drawings will illustrate the various embodiments. The following description and drawings are illustrative of the invention and are not to be construed as limiting the invention. Numerous specific details are described to provide a thorough understanding of various embodiments of the present invention. However, in certain instances, well-known or conventional details are not described in order to provide a concise discussion of embodiments of the present inventions.

Reference in the specification to “one embodiment” or “an embodiment” means that a particular feature, structure, or characteristic described in conjunction with the embodiment can be included in at least one embodiment of the invention. The appearances of the phrase “in one embodiment” in various places in the specification do not necessarily all refer to the same embodiment.

Bracketed text and blocks with dashed borders (e.g., large dashes, small dashes, dot-dash, and dots) may be used herein to illustrate optional operations that add additional features to embodiments of the invention. However, such notation should not be taken to mean that these are the only options or optional operations, and/or that blocks with solid borders are not optional in certain embodiments of the invention.

In the following description and claims, the terms “coupled” and “connected,” along with their derivatives, may be used. It should be understood that these terms are not intended as synonyms for each other. “Coupled” is used to indicate that two or more elements, which may or may not be in direct physical or electrical contact with each other, co-operate or interact with each other. “Connected” is used to indicate the establishment of communication between two or more elements that are coupled with each other.

The embodiments can be implemented in numerous ways, including as a process, an apparatus, a system, a composition of matter, a computer readable medium such as a computer readable storage medium or a computer network wherein program instructions are sent over optical or communication links. A component such as a processor or a memory described as being configured to perform a task includes a general component that is temporarily configured to perform the task at a given time and/or a specific component that is manufactured to perform the task. In general, the order of the steps of disclosed processes can be altered within the scope of the invention.

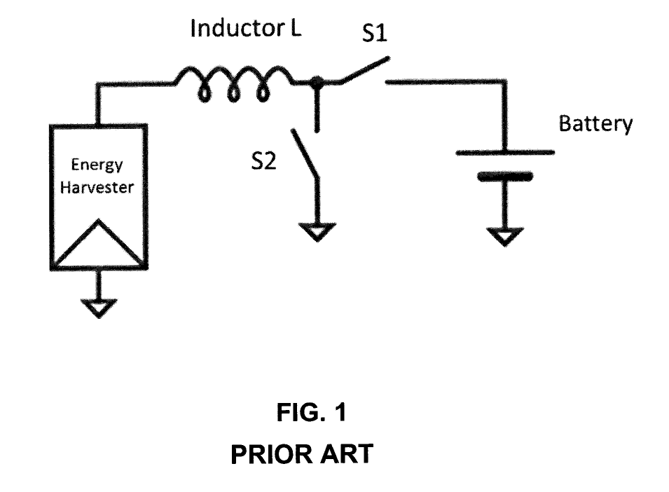

FIG. 1 is a conventional circuit diagram illustrating a single source power management according to prior art. Specifically, FIG. 1 illustrates an exemplary circuit diagram of a conventional buck-boost converter for a single harvesting energy source. The conventional buck-boost converter typically includes a single harvesting energy source, a large inductor, a large decoupling capacitor, one or more switches, and large battery. This conventional buck-boost converter circuit is typically only configured to operate with a single type of energy source (e.g., a single PV cell, a PZT vibration transducer TEG, etc.), and therefore can only generate a partial of the energy demanded from a sensor load. Furthermore, the conventional boost converter generally operates with a large converter ratio that causes a decrease in the power conversion efficiency.

For example, in order to charge a battery load (e.g., a Li-ion battery (4.2V/battery cell)), a boost DC/DC power converter (as shown in FIG. 1) is applied to step up a low input voltage (e.g., from PV˜0.5V or TEG˜<100 mV) from a single harvesting energy source. Consequently, this large voltage conversion ratio (e.g., >8×/PV or ˜40×/TEG)) is obviously a drawback in terms of power efficiency (e.g., typically <70%). In addition, it leads to a big power inductor (e.g., >50 uH-1 mH, ˜1 cm×1 cm in foot print) that is required to reduce power consumption and mitigate current ripple.

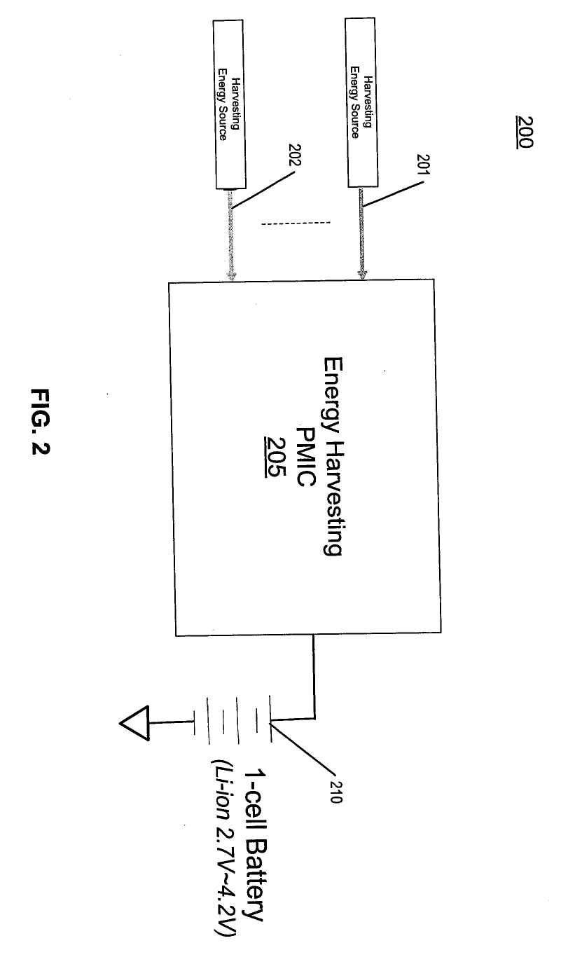

FIG. 2 is a block diagram illustrating an energy harvesting PMIC system according to one embodiment. It is pointed out that the components of FIG. 2 that have the same reference numbers (or names) as components of any other figure can operate or function in any manner similar to that described herein, but are not limited to such. Further, the lines connecting the blocks represent communication between different components of a power management integrated circuit.

Referring now to FIG. 2. In one embodiment, the energy harvesting PMIC system 200 includes, but is not limited to, harvesting energy sources 201-202, energy harvesting PMIC 205, and battery 210. According to one embodiment, the energy harvesting PMIC system 200 provides a power management integrated circuit (e.g., energy harvesting PMIC 205) that can handle the input of multiple energy sources (e.g., energy sources 201-202) and harvest the multiple inputs simultaneously in order to charge a battery (e.g., battery 210) and supply a regulated voltage to a load (e.g., a smart sensor node). In one embodiment, energy harvesting PMIC 205 is coupled between harvesting energy sources 201-202 and battery 210 (may also be referred to as a load).

Harvesting energy sources 201-202 (also referred to as energy sources) are power sources for supplying power (i.e., energy) for multi-source energy harvesting. Furthermore, harvesting energy sources 201-202 are not limited to a particular number of energy sources. For example, as shown in FIG. 2, harvesting energy source 202 refers to a total number “N” of harvesting energy sources that are available, which may be 2, 3, or any other number of total harvesting energy sources.

In one embodiment, harvesting energy sources 201-202 are not limited to a particular energy source. As such, harvesting energy sources 201-202 may include a thermal energy source, a mechanical energy source, and/or an electromagnetic energy source, where each energy source may be a photovoltaic (PV) cell, a radio frequency (RF) device, a piezoelectric (PZT) material, a thermoelectric generator (TEG), and/or any combination of sources. For example, harvesting energy sources 201-20 may be identical or different energy sources. In one embodiment, harvesting energy sources 201-202 supply their respective powers either simultaneously or at different times. The outputs of the corresponding power sources are connected to the input terminals of energy harvesting PMIC 205, where harvesting energy source 201 is connected to a first input terminal of energy harvesting PMIC 205 and harvesting energy source 202 is connected to a second input terminal (or a “N” input terminal) of energy harvesting PMIC 205.

According to one embodiment, energy harvesting PMIC 205 is configured to receive and efficiently manage power from the respective harvesting energy sources when power from harvesting energy sources 201-202 are input simultaneously (or at different times). Energy harvesting PMIC 205 is also configured to harvest power from harvesting energy sources 201-202 (i.e., accumulate power from each harvesting energy source substantially at the same time or concurrently), and distribute and supply the energy harvesting powers to battery 210.

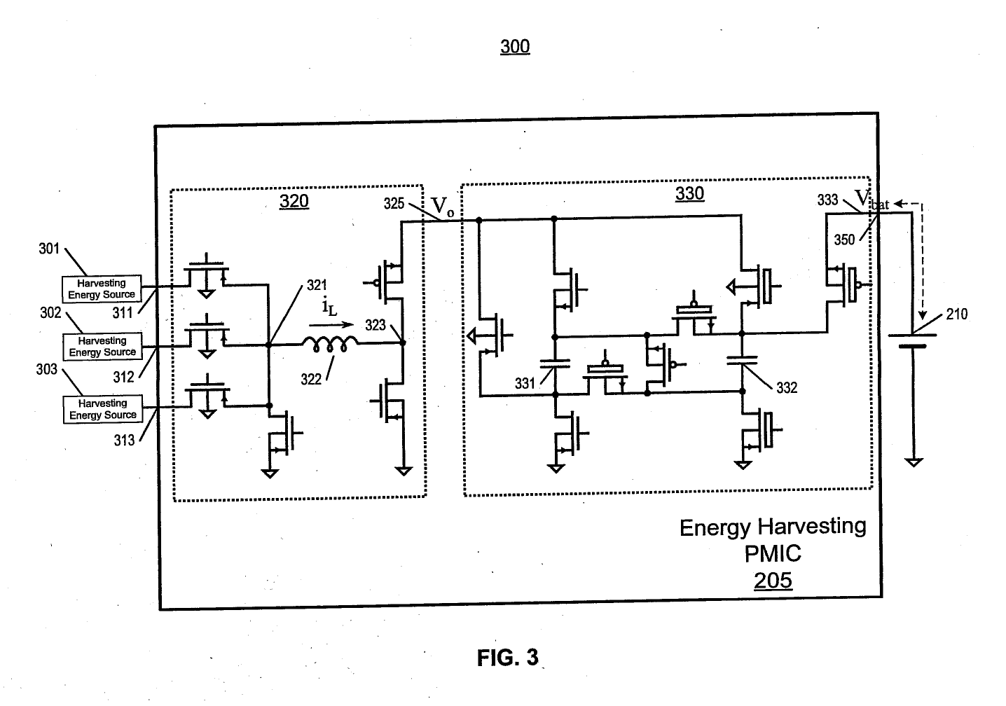

Energy harvesting PMIC 205 may include one or more circuits, electrical devices, and/or power stages that are configured to receive power from multiple energy sources and accumulate the total input power in order to provide an increased power supply to battery 210. In one embodiment, energy harvesting PMIC 205 implements a two-stage hybrid switching topology to charge battery 210 (and power a load) with multiple harvested energy sources. Energy harvesting PMIC 205 is also discussed in further detail below as shown in FIG. 3.

In one embodiment, energy harvesting PMIC 205 is configured to provide a regulated voltage (e.g., Vbat as shown in FIG. 3) that can be efficiently stored in battery 210. Battery 210 can accumulate charge from any or all of the harvesting energy sources 201-202 via energy harvesting PMIC 205. In one embodiment, battery 210 may be a rechargeable battery (e.g., Li-ion 2.7V-4.2V), a thin film battery, and any other load/battery configuration. According to one embodiment, battery 210 may be used for an IOT smart sensor node for self-powering. In one embodiment, battery 210 may be a load that includes one or more of the following: a smart sensor node, a signal conditioning circuit, a processor, a memory, a timekeeper, a wireless communication device, a light, an actuator, and/or any combination of loads.

According to one embodiment, energy harvesting PMIC 205 includes a boost converter that receives a plurality of first power supplies (e.g., energy sources 201-202) and generates an intermediate voltage from the multiple input power supplies. The boost converter includes a plurality of input terminals that are coupled to the plurality of first power supplies. Energy harvesting PMIC 205 also includes a switched capacitor charge pump that receives the intermediate voltage and generates a second power supply to charge a battery (e.g., battery 210) and power a load.

In another embodiment, the energy harvesting PMIC system 200 may include: providing a PMIC (e.g., energy harvesting PMIC 205) that includes a boost converter and a switched capacitor charge pump; receiving a plurality of first power supplies (e.g., energy sources 201-202) at a plurality of input terminals of the boost converter; generating an intermediate voltage at an output of the boost converter; receiving the intermediate voltage at an input of the switched capacitor charge pump; and generating a second power supply at an output of the switched capacitor charge pump. The second power supply of PMIC may be used to charge a battery and provide power to a load, such as an IOT smart sensor node.

Note that some or all of the components as shown and described above (e.g., energy harvesting PMIC 205) may be implemented in software, hardware, and/or a combination thereof. For example, such components can be implemented as software installed and stored in a persistent storage device, which can be loaded and executed in a memory by a processor (not shown) to carry out the processes or operations described throughout this application. Alternatively, such components can be implemented as executable code programmed or embedded into dedicated hardware such as an integrated circuit (e.g., an application specific IC or ASIC), a digital signal processor (DSP), or a field programmable gate array (FPGA), which can be accessed via a corresponding driver and/or operating system from an application. Furthermore, such components can be implemented as specific hardware logic in a processor or processor core as part of an instruction set accessible by a software component via one or more specific instructions. Also note that the configuration shown in FIG. 2 shall be referenced throughout the description.

FIG. 3 is a detailed circuit diagram illustrating an energy harvesting PMIC with a two-stage hybrid switching topology according to one embodiment. Specifically, a detailed energy harvesting PMIC system 300 illustrates an energy harvesting PMIC that includes a two-stage hybrid switching power management configuration. FIG. 3 illustrates an example of interactions between different components of an energy harvesting PMIC. It is pointed out that the components of FIG. 3 that have the same reference numbers (or names) as components of any other figure can operate or function in any manner similar to that described herein, but are not limited to such. Further, the lines connecting the components represent communication between different components of the detailed energy harvesting PMIC system 300.

Referring now to FIG. 3. In one embodiment, system 300 includes, but is not limited to, energy harvesting PMIC 205, harvesting energy sources 301-303, and battery 210. As discussed above, harvesting energy sources 301-303 are not limited to a particular number of energy sources and a particular energy source. Each harvesting energy source provides an input power supply to an input terminal of energy harvesting PMIC 205, where each input power supply may be identical or different to the other energy sources and may be provided at the same or different time as the other energy sources. In one embodiment, multiple energy conversion devices, based on sunlight, heat, piezoelectricity (vibration), and any other energy source, are configured to acquire energy from multiple harvesting energy sources (e.g., energy sources 301-303) and convert the acquired energy into one or more input power supplies.

According to one embodiment, energy harvesting PMIC 205 includes, but is not limited to, input terminals 311-313, boost converter 320, switching capacitor charge pump 330, and output terminal 350. Energy harvesting PMIC 205 provides a two-stage hybrid switching topology to charge a battery (and power a load) from multiple harvested energy sources. For example, energy harvesting PMIC 205 includes a high frequency boost converter in the front-end stage, and a switching capacitor charging pump converter that operates at a low frequency (e.g., 5×-10× slower) in the back-end stage. The two-stage hybrid switching topology provides a soft-charging charge pump that provides relatively no charge sharing losses and smaller capacitors operating at a lower frequency. The two-stage hybrid switching topology also provides a low voltage boost converter that provides a higher switching frequency, a smaller inductor, and a smaller decoupling capacitor.

In one embodiment, boost converter 320 receives multiple input power supplies via input terminals 311-313 and generates an intermediate power supply (e.g., intermediate voltage 325 (Vo)), which is a boosted higher power supply compared to the input power supply. According to one embodiment, switching capacitor charge pump 330 receives the intermediate power supply and generates/bumps a higher second power supply (e.g., Vbat 333) using the intermediate power supply. For example, switching capacitor charge pump 330 may receive an intermediate voltage and pump that intermediate voltage using switch capacitors (e.g., capacitors 331-332) to generate an output power supply at a fixed ratio of 1:2 or 1:3 (i.e., 1:2/1:3 refers to the output power supply that is generally twice/three times higher than the intermediate voltage). As such, output terminal 350 receives the higher second power supply (Vbat) and forwards the higher second power supply to charge battery 210 and power a load.

In one embodiment, boost converter 320 includes, but is not limited to, node 321, inductor 322 (i_{L}), node 323, and intermediate voltage 325 (Vo). According to one embodiment, boost converter 320 is configured to “boost” its output to an intermediate voltage level, which can generally increase the power conversion efficiency. In addition, since boost converter 320 operates with a low voltage circuit/components (e.g., harvesting energy sources that are typically <˜2.5V), a more efficient low-voltage/high-frequency silicon process can be applied. As such, this provides two improvements to a PMIC: the front-end circuit can operate in high-frequency in order to meet a desired fast dynamical response, while also maintaining a good or compatibly high power efficiency; and the value of the switching inductor can be greatly reduced due to the high frequency switching.

In one embodiment, node 321 receives one or more input power supplies via input terminals 311-313, where the one or more input power supplies are received simultaneously (or at different times) and controlled by one or more field-effect transistors (FET). Inductor 321 is coupled between node 321 and 323. Furthermore, inductor 321 receives the input power supplies via node 321 and generates an output voltage level that is forwarded to node 322, which is controlled by FETs and coupled between an intermediate voltage (Vo) and a ground. Inductor 321 may be a switching inductor but is not limited to a particular type of inductor. Note that the overall power delivery efficiency of an energy harvesting PMIC is primarily dominated by the front-end boost converter.

For example, using a 4.7 uH switching inductor which is roughly 10× smaller than a conventional inductor (as shown in FIG. 1), the energy harvesting PMIC generates an overall power efficiency that is, at a minimum, generally higher (e.g., 3%˜5%) than a conventional boost converter as illustrated in FIG. 1. In addition, the overall power efficiency is even greater (e.g., 7%˜10% when using a 1 uH switching inductor) when there is a demand for an even smaller foot print design. Note that the architecture is naturally “expendable” to multiple harvesting sources, since it utilizes the switching inductor (e.g., switching inductor 322) of the front-end boost converter (e.g., boost converter 320) in such a method where a total energy from all the input energy sources can be harvested & delivered effectively to charge a battery and power a load. Also, note that boost converter 320 is not limited to a particular type of boost converter and thus may include a high-efficiency buck-boost power converter, a step-up converter, a DC-to-DC power converter, and/or any boost (step-up) converter.

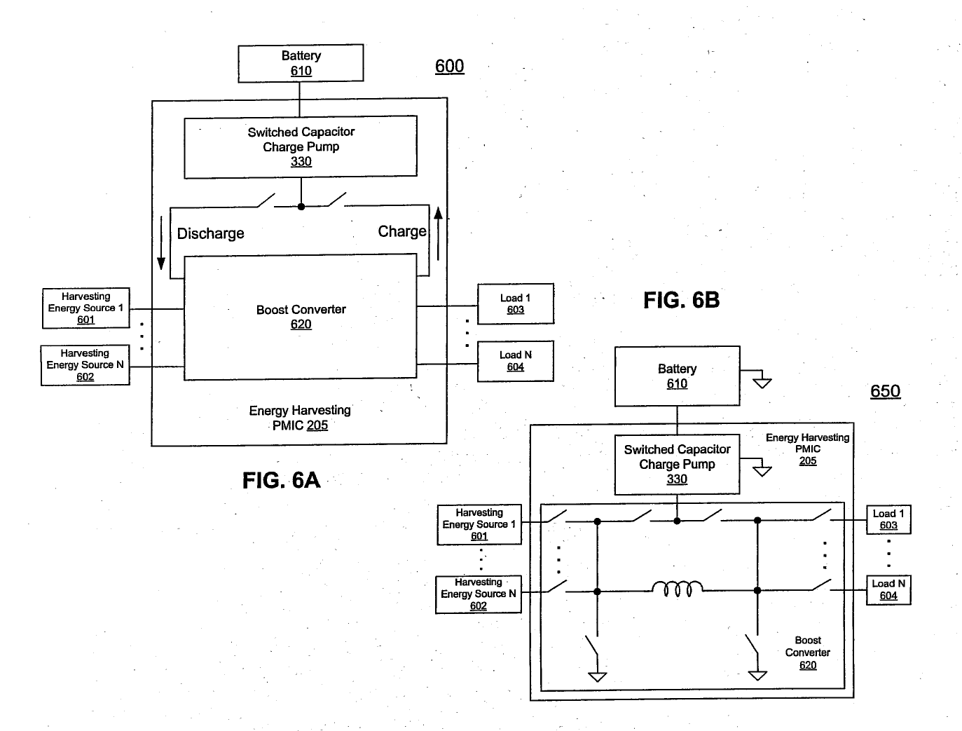

Furthermore, according to some embodiments, boost converter 320 provides a DCM operation that includes receiving multiple input energy sources and generating multiple output power supplies. In one embodiment, boost converter 320 may include one or more outputs using inductor 322 and the multiple inputs from node 321. For example, there could be more than one high-side device connected to node 323, where each of the additional outputs may be a low voltage device (e.g., a processor). Furthermore, in one embodiment, each additional output (or all the outputs) from boost converter 320 may be regulated and configured, for example, to only supply the excess energy from the energy sources to the battery. In another embodiment, energy harvesting PMIC 205 may include a battery-operating mode (described in further detail in FIGS. 6A-B). In the battery-operating mode, battery 210 operates as a power source (as shown by the bi-directional dotted line) and supplies power to the energy harvesting PMIC 205 when the input power supply from harvesting energy sources 301-303 is not sufficient (i.e., the input power supplies fall below a low voltage threshold).

In one embodiment, switching capacitor charge pump 330 includes, but is not limited to, intermediate voltage 325, capacitors 331-332, and supply voltage 333 (e.g., Vbat). Switching capacitor charge pump 330 operates in a step-up mode with a fixed conversion ratio (1:2, 1:3, etc.), which is self-adapted to an input source. The back-end charge pump of energy harvesting PMIC 205 also provides a higher overall power efficiency (e.g., efficiency at 95%˜98%). According to one embodiment, switching capacitor charge pump 330 receives intermediate voltage 325 and generates/bumps supply voltage 333 (Vbat) using the intermediate voltage, capacitors 331-332, and multiple FETs. Furthermore, intermediate voltage 325 (Vo) should operate within a threshold range (e.g., an upper and lower voltage thresholds), which can dynamically change based on the supply voltage 333 (Vbat). For example, if supply voltage 333 (Vbat) rises above the threshold range, the conversion ratio of the switching capacitor charge pump 330 is increased (e.g., from 1:2 to 1:3). Therefore, when the conversion rate is changed, the threshold range for intermediate voltage 325 (Vo) is also changed.

For example, when the switching capacitor charge pump 330 is in a 1:2 mode, the threshold for Vo is (Vbat/2) plus a voltage window/range, and in a 1:3 mode the threshold for Vo is changed to (Vbat/3) plus a voltage window/range. As such, the voltage is contained within an operating voltage range to maintain Vo within the voltage rating of the boost converter. Note that the voltage window may be the same or different in different modes. Furthermore, to avoid from switching back and forth in the presence of noise, switching capacitor charge pump 330 also includes a small hysteresis band to account for the presence of noise according to one embodiment.

In one embodiment, switching capacitor charge pump 330 charges into and out of capacitors 331-332 when the FETs (or switches) are opened and closed. Note that switching capacitor charge pump 330 is not limited to a particular charge pump configuration. Switching capacitor charge pump 330 includes a charging phase, a discharging phase, and a transition state (e.g., the moment the pump is triggered from a charging phase to a discharging phase). During the charge phase according to one embodiment, capacitor 331 may operate as a flying capacitor (C_{FLY}) and is charged to a proper voltage by configuring it to be in parallel with battery 210. Meanwhile, capacitor 332 may operate as a load capacitor (C_{L}) and supplies a charge to a load. During the discharge phase according to one embodiment, capacitor 331 is placed in series with battery 210 and discharged into the load and capacitor 332, which effectively provides a fixed ratio of double/triple the supply voltage (Vbat) to the load. Therefore, intermediate voltage 325 (Vo) controls a transition state in switching capacitor charge pump 330 (e.g., from a charging phase to a discharge phase). The transition state is triggered when intermediate voltage 325 (Vo) reaches an upper threshold (which may also change based on the chosen conversion ratio). Furthermore, the state transition is only triggered after a complete pulse from boost converter 320, not during a pulse. Accordingly, intermediate voltage 325 (Vo) is sampled after a pulse has completed and then switching capacitor charge pump 330 decides whether to trigger a transition or not based on Vo and Vbat.

Note that some or all of the components as shown and described above (e.g., energy harvesting PMIC) may be implemented in software, hardware, or a combination thereof. For example, such components can be implemented as software installed and stored in a persistent storage device, which can be loaded and executed in a memory by a processor (not shown) to carry out the processes or operations described throughout this application. Alternatively, such components can be implemented as executable code programmed or embedded into dedicated hardware such as an integrated circuit (e.g., an application specific IC or ASIC), a digital signal processor (DSP), or a field programmable gate array (FPGA), which can be accessed via a corresponding driver and/or operating system from an application. Furthermore, such components can be implemented as specific hardware logic in a processor or processor core as part of an instruction set accessible by a software component via one or more specific instructions.

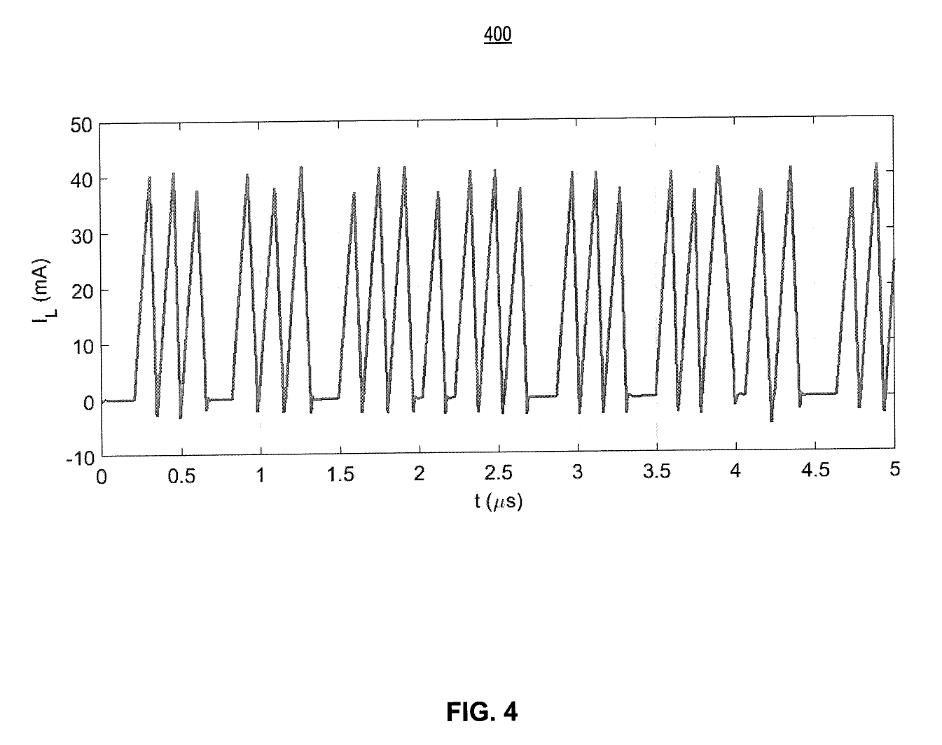

FIG. 4 is a graph illustrating current and time values when an energy harvesting PMIC is operated according to one embodiment. Specifically, graph 400 illustrates an operation window of a front-end boost conversion stage of an energy harvesting PMIC that inputs three harvesting energy sources (e.g., PV cells). As shown in FIG. 3, the current of switching inductor (I_{L}) is “time-shared” among the three input sources (e.g., energy harvesting sources 301-303). Referring now to FIG. 4. According to one embodiment, a scheduler controller (not shown), which can arbitrate on a first-come-first-server (FCFS) basis, and a pulse-frequency modulation (PFM) controller (not shown) are used to implement a PFM configuration that has a discontinuous conduction mode. For example, the multiple harvesting energy sources may be selected based on FCFS basis using the scheduler, which arbitrates among the multiple energy sources. Therefore, graph 400 illustrates a constant on-time pulse triggered current (I_{L}(mA)) versus time (μs) that shows the “time-shared” current among the three energy sources within a selected time interval.

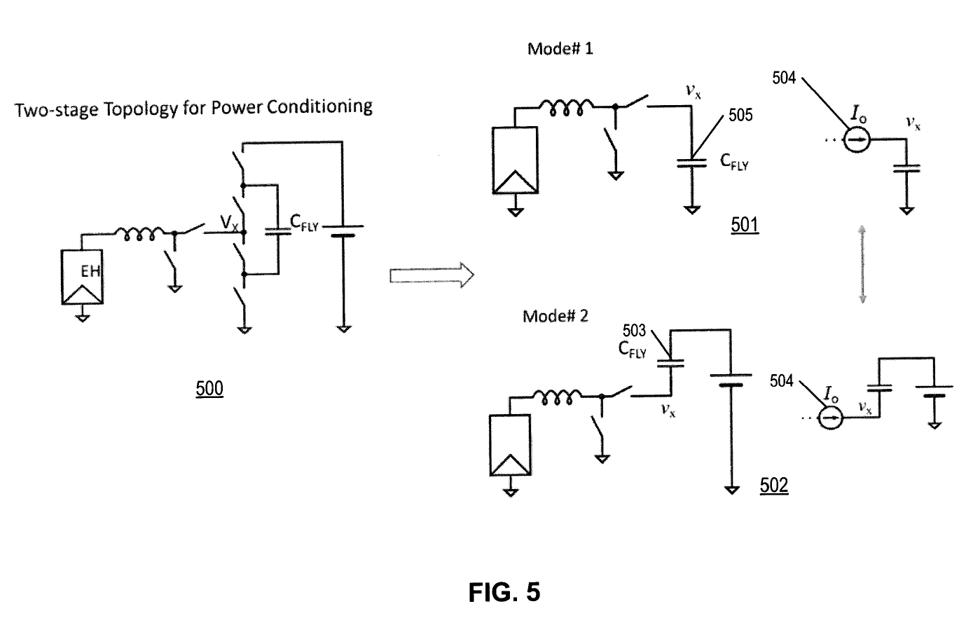

FIG. 5 is a detailed circuit diagram illustrating power conversion and control of a two-stage topology according to one embodiment. FIG. 5 illustrates an example of interactions between different components of energy harvesting PMIC 205. It is pointed out that the components of FIG. 5 that have the same reference numbers (or names) as components of any other figure can operate or function in any manner similar to that described herein, but are not limited to such. Further, the lines connecting the components represent communication between different components of energy harvesting PMIC 205.

Referring now to FIG. 5. System 500 shows a two-stage hybrid switching topology for power conditioning. In one embodiment, system 500 includes mode 1 501 and mode 2 502. System 500 is configured to transition between operation modes using multiple switches (or FETs). Mode 1 501 illustrates a charging phase in the energy harvesting PMIC. Mode 1 501 includes flying capacitor 505 and output current 504 (Io). Mode 2 502 illustrates a discharging phase (also referred to as a release phase) in the energy harvesting PMIC. Mode 2 502 includes flying capacitor 503 and output current 504 (Io). Note that flying capacitors 503 and 505 may be the same capacitor or different capacitors.

According to one embodiment, system 500 illustrates a power conversion and control of a two-stage hybrid switching topology of an energy harvesting PMIC. Since the boost converter in the front-stage operates at a higher switching frequency compared to the switching capacitor charge pump in the second-stage, an output current of the boost converter or an input current at Vx (a voltage point) are close to a constant value for the switching capacitor operation/analysis. Therefore, the “soft charge” to the C_{FLY} is achieved and illustrated as output current 504 (Io), which is a constant current even during the transition of operation modes 501-502.

In one embodiment, mode 1 501 illustrates a charging phase for the energy harvesting PMIC by providing output current 504 to charge flying capacitor 505 (C_{FLY}). Meanwhile, mode 2 502 illustrates a discharging phase for the energy harvesting PMIC by putting output current 504 and flying capacitor 503 into series and supplying a load. As such, the two-stage hybrid switching topology provides two modes 501-502 that allows self-powering for an IOT smart sensor node and also improves the overall power efficiency due to the elimination of the “hard” power loss associated with a conventional switching capacitor converter.

FIG. 6A is a block diagram illustrating a battery-operating mode according to one embodiment. Figured 6B is a detailed circuit diagram illustrating a battery-operating mode according to one embodiment. FIG. 6-B illustrate an example of interactions between different components of energy harvesting PMIC 205. It is pointed out that the components of FIG. 6-B that have the same reference numbers (or names) as components of any other figure can operate or function in any manner similar to that described herein, but are not limited to such. Further, the lines connecting the components represent communication between different components of energy harvesting PMIC 205.

Referring now to FIG. 6A. System 600 illustrates harvesting energy sources 601-602, energy harvesting PMIC 205, boost converter 620, switched capacitor charge pump 330, battery 610, and loads 603-604. According to one embodiment, energy harvesting PMIC 205 implements battery 610 (or any other energy storage device) to operate as a power source or a load. In one embodiment, when battery 610 operates as a power source, switch capacitor charge pump 330 receives power from battery 610 and forwards the power to boost converter 610 via a “Discharge” path (as shown in FIG. 6A). In one embodiment, when battery 610 operates as a load, switch capacitor charge pump 330 receives power from boost converter 620 and forwards the power to battery 610 via a “Charge” path (as shown in FIG. 6A).

Loads 603-604 are not limited to any particular type of load. For example, a load may include an IOT smart sensor node, a CPU, a mobile phone, etc. In one embodiment, if the power provided by harvesting energy sources 601-602 are greater than the power required to supply loads 603-604 (i.e., all the loads of system 600), battery 610 operates as the load. Furthermore, the energy (e.g., excess energy) that is not required to supply loads 603-604 is used to charge battery 610 through the “charge” path, as shown in FIG. 6A. Meanwhile, if the power required to supply loads 603-604 is greater than the power provided by harvesting energy sources 601-602, battery 610 operates as the power source and supplies power through the “discharge” path to boost converter 620, as shown in FIG. 6A.

Referring now to FIG. 6B. FIG. 6B illustrates an exemplary circuit diagram of FIG. 6A. Specifically, system 650 illustrates energy harvesting PMIC 205 configured in a battery-operating mode. In the battery-operating mode, according to one embodiment, boost converter 620 receives energy from battery 610 through switched capacitor charge pump 330 at its input, and/or supplies power to battery 610 through switched capacitor charge pump 330 at its output. For example, energy/power may be supplied/flow from all the energy sources and/or the battery to all the loads and/or the battery, while regulating all the energy sources and load voltages by sourcing or supplying the difference between the available source power and the required load power from/to the battery. Note that boost converter 620 may include multiple inputs of energy sources, including an input power supply from a battery, and multiple outputs. As such, booster converter 620 can operate or function in any manner similar to that described herein (i.e., boost converter 320), but is not limited to such.

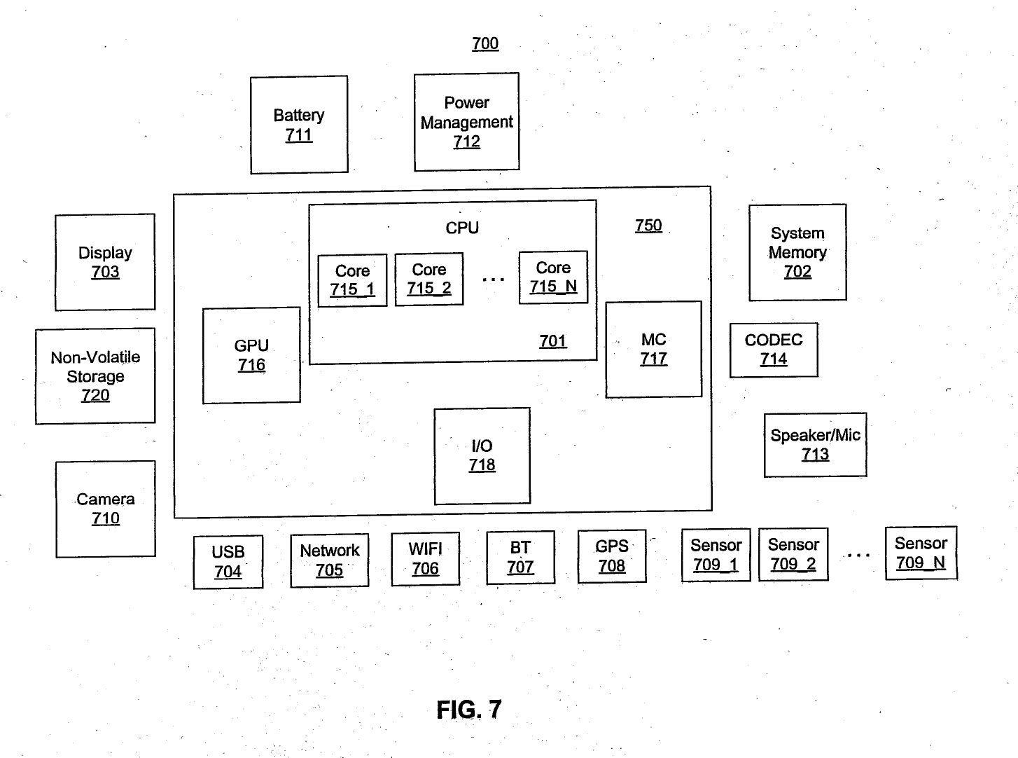

FIG. 7 illustrates a depiction of an exemplary computing system 700 such as a personal computing system (e.g., desktop or laptop) or a mobile or handheld computing system such as a tablet device or smartphone. As illustrated in FIG. 7, the basic computing system may include a central processing unit 701 (which may include, e.g., a plurality of general purpose processing cores and a main memory controller disposed on an applications processor or multi-core processor), system memory 702, a display 703 (e.g., touchscreen, flat-panel), a local wired point-to-point link (e.g., USB) interface 704, various network I/O functions 705 (such as an Ethernet interface and/or cellular modem subsystem), a wireless local area network (e.g., Wi-Fi) interface 706, a wireless point-to-point link (e.g., Bluetooth) interface 707 and a Global Positioning System interface 708, various sensors 709_1 through 709_N (e.g., one or more of a gyroscope, an accelerometer, a magnetometer, a temperature sensor, a pressure sensor, a humidity sensor, etc.), a camera 710, a battery 711, a power management control unit 712, a speaker and microphone 713 and an audio coder/decoder 714.

An applications processor or multi-core processor 750 may include one or more general purpose processing cores 715 within its CPU 701, one or more graphical processing units 716, a memory management function 717 (e.g., a memory controller) and an I/O control function 718. The general-purpose processing cores 715 typically execute the operating system and application software of the computing system. The graphics processing units 716 typically execute graphics intensive functions to, e.g., generate graphics information that is presented on the display 703. The memory control function 717 interfaces with the system memory 702. During operation, data and/or instructions are typically transferred between deeper non-volatile (e.g., “disk”) storage 720 and system memory 702. The power management control unit 712 generally controls the power consumption of the system 700. For example, a power management control unit may control and manage an energy harvesting PMIC in order to receive power from one or more energy harvesting sources.

Each of the touchscreen display 703, the communication interfaces 704-707, the GPS interface 708, the sensors 709, the camera 710, and the speaker/microphone codec 713, 714 all can be viewed as various forms of I/O (input and/or output) relative to the overall computing system including, where appropriate, an integrated peripheral device as well (e.g., the camera 710). Depending on implementation, various ones of these I/O components may be integrated on the applications processor/multi-core processor 750 or may be located off the die or outside the package of the applications processor/multi-core processor 750.

Embodiments of the invention may include various processes as set forth above. The processes may be embodied in machine-executable instructions. The instructions can be used to cause a general-purpose or special-purpose processor to perform certain processes. Alternatively, these processes may be performed by specific hardware components that contain hardwired logic for performing the processes, or by any combination of programmed computer components and custom hardware components.

Elements of the present invention may also be provided as a machine-readable medium for storing the machine-executable instructions. The machine-readable medium may include, but is not limited to, floppy diskettes, optical disks, CD-ROMs, and magneto-optical disks, FLASH memory, ROMs, RAMs, EPROMs, EEPROMs, magnetic or optical cards, propagation media or other type of media/machine-readable medium suitable for storing electronic instructions. For example, the present invention may be downloaded as a computer program which may be transferred from a remote computer (e.g., a server) to a requesting computer (e.g., a client) by way of data signals embodied in a carrier wave or other propagation medium via a communication link (e.g., a modem or network connection).

Some portions of the preceding detailed descriptions have been presented in terms of algorithms and symbolic representations of transactions on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of transactions leading to a desired result. The transactions are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The algorithms and displays presented herein are not inherently related to any particular computer or other apparatus. Various general-purpose systems may be used with programs in accordance with the teachings herein, or it may prove convenient to construct more specialized apparatus to perform the required method transactions. The required structure for a variety of these systems will appear from the description above. In addition, embodiments of the present invention are not described with reference to any particular programming language. It will be appreciated that a variety of programming languages may be used to implement the teachings of embodiments of the invention as described herein.

In the foregoing specification, embodiments of the invention have been described with reference to specific exemplary embodiments thereof. It will be evident that various modifications may be made thereto without departing from the broader spirit and scope of the invention as set forth in the following claims. The specification and drawings are, accordingly, to be regarded in an illustrative sense rather than a restrictive sense.

Throughout the description, embodiments of the present invention have been presented through flow diagrams. It will be appreciated that the order of transactions and transactions described in these flow diagrams are only intended for illustrative purposes and not intended as a limitation of the present invention. One having ordinary skill in the art would recognize that variations can be made to the flow diagrams without departing from the broader spirit and scope of the invention as set forth in the following claims.

The following examples pertain to further embodiments:

A power management integrated circuit (PMIC), comprising, a boost converter to receive a plurality of first power supplies and to generate an intermediate voltage, the boost converter having a plurality of input terminals coupled to the plurality of first power supplies; and a switched capacitor charge pump to receive the intermediate voltage and to generate a second power supply.

A power management integrated circuit (PMIC), comprising, a boost converter to receive a plurality of first power supplies and to generate an intermediate voltage, the boost converter having a plurality of input terminals coupled to the plurality of first power supplies; and a switched capacitor charge pump to receive the intermediate voltage and to generate a second power supply, wherein the switched capacitor charge pump is configured to operate in a step-up mode, and wherein in the step-up mode the charge pump can step-up the intermediate voltage at a ratio of at least one of 1:2 and 1:3.

A power management integrated circuit (PMIC), comprising, a boost converter to receive a plurality of first power supplies and to generate an intermediate voltage, the boost converter having a plurality of input terminals coupled to the plurality of first power supplies; a switched capacitor charge pump to receive the intermediate voltage and to generate a second power supply; and a load to receive the second power supply, wherein the load includes a battery that operates as an input power supply of the boost converter if the plurality of first power supplies drops below a voltage threshold.

A power management integrated circuit (PMIC), comprising, a boost converter to receive a plurality of first power supplies and to generate an intermediate voltage, the boost converter having a plurality of input terminals coupled to the plurality of first power supplies, wherein the boost converter includes a switching inductor coupled between a first node and a second node, the first node to receive the plurality of first power supplies, and the second node coupled between the intermediate voltage and a ground; and a switched capacitor charge pump to receive the intermediate voltage and to generate a second power supply.

A power management integrated circuit (PMIC), comprising, a boost converter to receive a plurality of first power supplies and to generate an intermediate voltage, the boost converter having a plurality of input terminals coupled to the plurality of first power supplies; a switched capacitor charge pump to receive the intermediate voltage and to generate a second power supply; and a plurality of energy conversion devices configured to acquire energy from a plurality of energy harvesting sources and convert the acquired energy into the plurality of first power supplies.

A power management integrated circuit (PMIC), comprising, a boost converter to receive a plurality of first power supplies and to generate an intermediate voltage, the boost converter having a plurality of input terminals coupled to the plurality of first power supplies, wherein the boost converter generates a plurality of intermediate voltages coupled to a plurality of output terminals and operates in a discontinuous conduction mode, and further comprises a pulse frequency modulation controller; and a switched capacitor charge pump to receive the intermediate voltage and to generate a second power supply.

A power management integrated circuit (PMIC), comprising, a boost converter to receive a plurality of first power supplies and to generate an intermediate voltage, the boost converter having a plurality of input terminals coupled to the plurality of first power supplies; a switched capacitor charge pump to receive the intermediate voltage and to generate a second power supply; and a plurality of energy conversion devices configured to acquire energy from a plurality of energy harvesting sources and convert the acquired energy into the plurality of first power supplies, wherein the plurality of energy conversion sources includes at least one of a photovoltaic (PC) cell, a thermoelectric generator (TEG), a radio frequency (RF) device, and a piezoelectric material.

A power management integrated circuit (PMIC), comprising, a boost converter to receive a plurality of first power supplies and to generate an intermediate voltage, the boost converter having a plurality of input terminals coupled to the plurality of first power supplies; and a switched capacitor charge pump to receive the intermediate voltage and to generate a second power supply, wherein the switched capacitor charge pump includes at least a plurality of charging circuits, a first capacitor to store charge, and a second capacitor to receive charge from the first capacitor, wherein the second capacitor is coupled to an output terminal of the charge pump.

A power management integrated circuit (PMIC), comprising, a boost converter to receive a plurality of first power supplies and to generate an intermediate voltage, the boost converter having a plurality of input terminals coupled to the plurality of first power supplies; and a switched capacitor charge pump to receive the intermediate voltage and to generate a second power supply, wherein the switched capacitor charge pump includes at least one of a charge mode and a discharging mode.

A system for energy harvesting, comprising, a load; a plurality of energy harvesting sources; and a power management integrated circuit (PMIC) having a boost converter to receive a plurality of first power supplies and to generate an intermediate voltage, the boost converter having a plurality of input terminals coupled to the plurality of first power supplies, and a switched capacitor charge pump to receive the intermediate voltage and to generate a second power supply.

A system for energy harvesting, comprising, a load; a plurality of energy harvesting sources; and a power management integrated circuit (PMIC) having a boost converter to receive a plurality of first power supplies and to generate an intermediate voltage, the boost converter having a plurality of input terminals coupled to the plurality of first power supplies, and a switched capacitor charge pump to receive the intermediate voltage and to generate a second power supply, wherein the switched capacitor charge pump is configured to operate in a step-up mode, and wherein in the step-up mode the charge pump can step-up the intermediate voltage at a ratio of at least one of 1:2 and 1:3.

A system for energy harvesting, comprising, a load; a plurality of energy harvesting sources; a power management integrated circuit (PMIC) having a boost converter to receive a plurality of first power supplies and to generate an intermediate voltage, the boost converter having a plurality of input terminals coupled to the plurality of first power supplies, and a switched capacitor charge pump to receive the intermediate voltage and to generate a second power supply; and a load to receive the second power supply, wherein the load includes a battery that operates as an input power supply of the boost converter if the plurality of first power supplies drops below a voltage threshold.

A system for energy harvesting, comprising, a load; a plurality of energy harvesting sources; and a power management integrated circuit (PMIC) having a boost converter to receive a plurality of first power supplies and to generate an intermediate voltage, the boost converter having a plurality of input terminals coupled to the plurality of first power supplies, wherein the boost converter includes a switching inductor coupled between a first node and a second node, the first node to receive the plurality of first power supplies, and the second node coupled between the intermediate voltage and a ground, and a switched capacitor charge pump to receive the intermediate voltage and to generate a second power supply.

A system for energy harvesting, comprising, a load; a plurality of energy harvesting sources; a power management integrated circuit (PMIC) having a boost converter to receive a plurality of first power supplies and to generate an intermediate voltage, the boost converter having a plurality of input terminals coupled to the plurality of first power supplies, and a switched capacitor charge pump to receive the intermediate voltage and to generate a second power supply; and a plurality of energy conversion devices configured to acquire energy from a plurality of energy harvesting sources and convert the acquired energy into the plurality of first power supplies.

A system for energy harvesting, comprising, a load; a plurality of energy harvesting sources; and a power management integrated circuit (PMIC) having a boost converter to receive a plurality of first power supplies and to generate an intermediate voltage, the boost converter having a plurality of input terminals coupled to the plurality of first power supplies, wherein the boost converter generates a plurality of intermediate voltages coupled to a plurality of output terminals and operates in a discontinuous conduction mode, and further comprises a pulse frequency modulation controller, and a switched capacitor charge pump to receive the intermediate voltage and to generate a second power supply.

A system for energy harvesting, comprising, a load; a plurality of energy harvesting sources; a power management integrated circuit (PMIC) having a boost converter to receive a plurality of first power supplies and to generate an intermediate voltage, the boost converter having a plurality of input terminals coupled to the plurality of first power supplies, and a switched capacitor charge pump to receive the intermediate voltage and to generate a second power supply; and a plurality of energy conversion devices configured to acquire energy from a plurality of energy harvesting sources and convert the acquired energy into the plurality of first power supplies, wherein the plurality of energy conversion sources includes at least one of a photovoltaic (PC) cell, a thermoelectric generator (TEG), a radio frequency (RF) device, and a piezoelectric material.

A system for energy harvesting, comprising, a load; a plurality of energy harvesting sources; and a power management integrated circuit (PMIC) having a boost converter to receive a plurality of first power supplies and to generate an intermediate voltage, the boost converter having a plurality of input terminals coupled to the plurality of first power supplies, and a switched capacitor charge pump to receive the intermediate voltage and to generate a second power supply, wherein the switched capacitor charge pump includes at least a plurality of charging circuits, a first capacitor to store charge, and a second capacitor to receive charge from the first capacitor, wherein the second capacitor is coupled to an output terminal of the charge pump.

A system for energy harvesting, comprising, a load; a plurality of energy harvesting sources; and a power management integrated circuit (PMIC) having a boost converter to receive a plurality of first power supplies and to generate an intermediate voltage, the boost converter having a plurality of input terminals coupled to the plurality of first power supplies, and a switched capacitor charge pump to receive the intermediate voltage and to generate a second power supply, wherein the switched capacitor charge pump includes at least one of a charge mode and a discharging mode.

A method for energy harvesting, comprising, a means for providing a power management integrated circuit (PMIC) including a boost converter and a switched capacitor charge pump; a means for receiving a plurality of first power supplies at a plurality of input terminals of the boost converter; a means for generating an intermediate voltage at an output of the boost converter; a means for receiving the intermediate voltage at an input of the switched capacitor charge pump; and a means for generating a second power supply at an output of the switched capacitor charge pump.

A method for energy harvesting, comprising, a means for providing a power management integrated circuit (PMIC) including a boost converter and a switched capacitor charge pump; a means for receiving a plurality of first power supplies at a plurality of input terminals of the boost converter; a means for generating an intermediate voltage at an output of the boost converter; a means for receiving the intermediate voltage at an input of the switched capacitor charge pump; a means for generating a second power supply at an output of the switched capacitor charge pump; and a means for receiving the second power supply at a load, wherein the load includes a battery operating as an input power supply of the boost converter if the plurality of first power supplies drops below a voltage threshold.

A method for energy harvesting, comprising, a means for providing a power management integrated circuit (PMIC) including a boost converter and a switched capacitor charge pump; a means for receiving a plurality of first power supplies at a plurality of input terminals of the boost converter; a means for generating an intermediate voltage at an output of the boost converter; a means for receiving the intermediate voltage at an input of the switched capacitor charge pump; a means for generating a second power supply at an output of the switched capacitor charge pump; and a means for providing a switching inductor of the boost convert coupled between a first node and a second node of the boost converter, wherein the second node is coupled between the intermediate voltage and a ground; and a means for receiving the plurality of first power supplies at the first node of the boost converter.

A method for energy harvesting, comprising, a means for providing a power management integrated circuit (PMIC) including a boost converter and a switched capacitor charge pump; a means for receiving a plurality of first power supplies at a plurality of input terminals of the boost converter; a means for generating an intermediate voltage at an output of the boost converter; a means for receiving the intermediate voltage at an input of the switched capacitor charge pump; a means for generating a second power supply at an output of the switched capacitor charge pump; and a means for acquiring energy from a plurality of energy harvesting sources using a plurality of energy conversion devices, wherein the plurality of energy conversion devices are configured to convert the acquired energy into the plurality of first power supplies.

A method for energy harvesting, comprising, a means for providing a power management integrated circuit (PMIC) including a boost converter and a switched capacitor charge pump; a means for receiving a plurality of first power supplies at a plurality of input terminals of the boost converter; a means for generating an intermediate voltage at an output of the boost converter; a means for receiving the intermediate voltage at an input of the switched capacitor charge pump; a means for generating a second power supply at an output of the switched capacitor charge pump; a means for generating a plurality of intermediate voltages coupled to a plurality of output terminals; a means for operating in a discontinuous conduction mode; and a means for providing a pulse frequency modulation controller.

A method for energy harvesting, comprising, a means for providing a power management integrated circuit (PMIC) including a boost converter and a switched capacitor charge pump; a means for receiving a plurality of first power supplies at a plurality of input terminals of the boost converter; a means for generating an intermediate voltage at an output of the boost converter; a means for receiving the intermediate voltage at an input of the switched capacitor charge pump; and a means for generating a second power supply at an output of the switched capacitor charge pump, wherein the switched capacitor charge pump further comprises at least one of a charge mode and a discharging mode; and wherein the switched capacitor charge pump further comprises at least a plurality of charging circuits, a first capacitor to store charge, and a second capacitor to receive charge from the first capacitor, wherein the second capacitor is coupled to an output terminal of the charge pump.

A method for energy harvesting, comprising, a means for providing a power management integrated circuit (PMIC) including a boost converter and a switched capacitor charge pump; a means for receiving a plurality of first power supplies at a plurality of input terminals of the boost converter; a means for generating an intermediate voltage at an output of the boost converter; a means for receiving the intermediate voltage at an input of the switched capacitor charge pump; and a means for generating a second power supply at an output of the switched capacitor charge pump, wherein the switched capacitor charge pump is configured to operate in a step-up mode, and wherein in the step-up mode the charge pump can step-up the intermediate voltage at a ratio of at least one of 1:2 and 1:3.

In the foregoing specification, methods and apparatuses have been described with reference to specific exemplary embodiments thereof. It will be evident that various modifications may be made thereto without departing from the broader spirit and scope of embodiments as set forth in the following claims. The specification and drawings are, accordingly, to be regarded in an illustrative sense rather than a restrictive sense.

What is claimed is:

1. A power management integrated circuit (PMIC), comprising:
a boost converter to receive a plurality of first power supplies and to generate an intermediate voltage, the boost converter having a plurality of input terminals coupled to the plurality of first power supplies; and
a switched capacitor charge pump to receive the intermediate voltage and to generate a second power supply.

2. The PMIC of claim 1, wherein the switched capacitor charge pump is configured to operate in a step-up mode, and wherein in the step-up mode the charge pump can step-up the intermediate voltage at a ratio of at least one of 1:2 and 1:3.

3. The PMIC of claim 1, further comprises a load to receive the second power supply, wherein the load includes a battery that operates as an input power supply of the boost converter if the plurality of first power supplies drops below a voltage threshold.

4. The PMIC of claim 1, wherein the boost converter includes a switching inductor coupled between a first node and a second node, the first node to receive the plurality of first power supplies, and the second node coupled between the intermediate voltage and a ground.

5. The PMIC of claim 1, further comprises a plurality of energy conversion devices configured to acquire energy from a plurality of energy harvesting sources and convert the acquired energy into the plurality of first power supplies.

6. The PMIC of claim 1, wherein the boost converter generates a plurality of intermediate voltages coupled to a plurality of output terminals and operates in a discontinuous conduction mode, and wherein the boost converter further comprises a pulse frequency modulation controller.

7. The PMIC of claim 5, wherein the plurality of energy conversion sources includes at least one of a photovoltaic (PC) cell, a thermoelectric generator (TEG), a radio frequency (RF) device, and a piezoelectric material.

8. The PMIC of claim 1, wherein the switched capacitor charge pump includes at least a plurality of charging circuits, a first capacitor to store charge, and a second capacitor to receive charge from the first capacitor, wherein the second capacitor is coupled to an output terminal of the charge pump.

9. The PMIC of claim 1, wherein the switched capacitor charge pump includes at least one of a charge mode and a discharging mode.

10. A system for energy harvesting, comprising:
a load;
a plurality of energy harvesting sources; and
a power management integrated circuit (PMIC) having
a boost converter to receive a plurality of first power supplies and to generate an intermediate voltage, the boost converter having a plurality of input terminals coupled to the plurality of first power supplies, and
a switched capacitor charge pump to receive the intermediate voltage and to generate a second power supply.

11. The system of claim 10, wherein the switched capacitor charge pump is configured to operate in a step-up mode, and wherein in the step-up mode the charge pump can step-up the intermediate voltage at a ratio of at least one of 1:2 and 1:3.

12. The system of claim 10, further comprises a load to receive the second power supply, wherein the load includes a battery that can operate as an input power supply of the boost converter if the plurality of first power supplies drops below a voltage threshold.

13. The system of claim 10, wherein the boost converter includes a switching inductor coupled between a first node and a second node, the first node to receive the plurality of first power supplies, and the second node coupled between the intermediate voltage and a ground.

14. The system of claim 10, further comprises a plurality of energy conversion devices configured to acquire energy from a plurality of energy harvesting sources and convert the acquired energy into the plurality of first power supplies.

15. The system of claim 10, wherein the boost converter generates a plurality of intermediate voltages coupled to a plurality of output terminals and operates in a discontinuous conduction mode, and wherein the boost converter further comprises a pulse frequency modulation controller.

16. The system of claim 14, wherein the plurality of energy conversion sources includes at least one of a photovoltaic (PC) cell, a thermoelectric generator (TEG), a radio frequency (RF) device, and a piezoelectric material.

17. The system of claim 10, wherein the switched capacitor charge pump includes at least a plurality of charging circuits, a first capacitor to store charge, and a second capacitor to receive charge from the first capacitor, wherein the second capacitor is coupled to an output terminal of the charge pump.

18. The system of claim 10, wherein the switched capacitor charge pump includes at least one of a charge mode and a discharging mode.

19. A method for energy harvesting, comprising:
a means for providing a power management integrated circuit (PMIC) including a boost converter and a switched capacitor charge pump;
a means for receiving a plurality of first power supplies at a plurality of input terminals of the boost converter;
a means for generating an intermediate voltage at an output of the boost converter;
a means for receiving the intermediate voltage at an input of the switched capacitor charge pump; and
a means for generating a second power supply at an output of the switched capacitor charge pump.

20. The method of claim 19, further comprising a means for receiving the second power supply at a load, wherein the load includes a battery that can operate as an input power supply of the boost converter if the plurality of first power supplies drops below a voltage threshold.

21. The method of claim 19, further comprising:
a means for providing a switching inductor of the boost convert coupled between a first node and a second node of the boost converter, wherein the second node is coupled between the intermediate voltage and a ground; and
a means for receiving the plurality of first power supplies at the first node of the boost converter.

22. The method of claim 19, further comprising:
a means for acquiring energy from a plurality of energy harvesting sources using a plurality of energy conversion devices, wherein the plurality of energy conversion devices are configured to convert the acquired energy into the plurality of first power supplies.

23. The method of claim 19, further comprising:
a means for generating a plurality of intermediate voltages coupled to a plurality of output terminals;
a means for operating in a discontinuous conduction mode; and
a means for providing a pulse frequency modulation controller.

24. The method of claim 19, wherein the switched capacitor charge pump further comprises at least one of a charge mode and a discharging mode; and wherein the switched capacitor charge pump further comprises at least a plurality of charging circuits, a first capacitor to store charge, and a second capacitor to receive charge from the first capacitor, wherein the second capacitor is coupled to an output terminal of the charge pump.

25. The method of claim 19, wherein the switched capacitor charge pump is configured to operate in a step-up mode, and wherein in the step-up mode the charge pump can step-up the intermediate voltage at a ratio of at least one of 1:2 and 1:3.
